(19) United States
(12) Patent Application Publication
(10) Pub. No.: US 2024/0420681 A1
(43) Pub. Date: Dec. 19, 2024

(54) SYSTEM AND METHOD OF PREPROCESSING INPUTS FOR CROSS-LANGUAGE VOCAL SYNTHESIS

(71) Applicant: Deep Media Inc., Oakland, CA (US)

(72) Inventor: Rijul Gupta, Oakland, CA (US)

(21) Appl. No.: 18/747,887

(22) Filed: Jun. 19, 2024

Related U.S. Application Data
(60) Provisional application No. 63/508,916, filed on Jun. 19, 2023.

(51) Int. Cl. G10L 13/10; G06F 40/58; G10L 13/047; G10L 13/06; G10L 17/02; G10L 17/18; G10L 25/18

(52) U.S. Cl. CPC G10L 13/10; G06F 40/58; G10L 13/047; G10L 13/06; G10L 17/02; G10L 17/18; G10L 25/18

(57) ABSTRACT

A system and method for synthesizing audio for translated text. The system and method include modifying an input text label to improve machine learning model outputs. In some embodiments, the text labels are modified using a phoneme generator configured to convert the raw text to phonemes. In some embodiments, the text labels are modified using a spacing character generator configured to input characters into the text to convey a gap in speech. Some embodiments include a pacing character generator to input characters into the text to convey the pace at which a phoneme, word, or sentence is spoken. Some embodiments include a non-verbal character generator to input characters into the text to convey when non-verbal speech occurs.

### CROSS-REFERENCE TO RELATED APPLICATIONS

This nonprovisional application claims priority to U.S. provisional application No. 63/508,916, entitled “System and Method of Preprocessing Inputs for Cross-Language Vocal Synthesis,” filed Jun. 19, 2023 by the same inventor(s).

### BACKGROUND OF THE INVENTION

### 1. Field of the Invention

This invention relates, generally, to vocal synthesis. More specifically, it relates to cross-language vocal synthesis.

### 2. Brief Description of the Prior Art

Current cross-language vocal synthesis is easily identifiable as non-human speech. The failure to produce speech that is indistinguishable from human speech is a result of the current approaches' inability to produce robust, high-quality, identity-aware, emotionally consistent, pace-consistent, text-conditioned cross-language vocal synthesis. These shortcomings are a result of various issues that are often intertwined and difficult to overcome.

Consider prior art architecture 100 in FIG. 1. As depicted therein, machine learning (ML) model 108 is trained to synthesize speech using a particular set of inputs which produce a particular set of outputs that can be assessed using particular loss functions. As depicted, the particular set of inputs include text label 102, speaker ID 104, and language code 106.

Using these inputs, ML model 108 produces several outputs including encoder output 110, stop token prediction 112, prenet mel spectrogram 114, and postnet mel spectrogram 116. Each of these outputs is analyzed using loss functions 118-124 in comparison to original mel spectrogram 126 or speaker ID 104 in the case of speaker prediction 128 from encoder output 110. The loss functions are each input back into ML model 108 and ML model 108 learns by adjusting parameters of the outputs until acceptable levels of loss are calculated.

Once model 108 is trained, it can be used during inference as depicted in FIG. 2. During inference, user-provided text label 130, user-provided speaker ID 132, and user-selected language code 134 are provided to model 108 to generate postnet mel spectrogram 116, which is eventually turned into synthetic speech in the selected language that generally coincides with the provided text and speaker ID. Unfortunately, this existing architecture with these inputs produces unrealistic outputs that have mispronunciations, incorrect pacing, and incorrect spacing; do not sound like original speaker; lack emotion, silences/pauses, breaths, laughs, coughs, etc.; produce poor quality audio; and are in 22.05 KHz resolution. Prior approaches to correct these shortcomings are mostly focused on increasing the training data and training time; however, those approaches are costly and resulted in limited improvements.

Accordingly, what is needed is an improved system and method for cross-language vocal synthesis. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved system and method for cross-language vocal synthesis is now met by a new, useful, and nonobvious invention.

The present invention relates to a comprehensive system and method for synthesizing translated speech using advanced machine learning techniques. This invention encompasses multiple aspects including the training of machine learning models, preprocessing of input data, generation of refined audio outputs, and the integration of various generators for transforming the inputs using phonemes, pacing, spacing, and/or non-verbal elements. By addressing the end-to-end process of speech synthesis, from text input to high-quality audio output, the invention provides a unified solution that improves the accuracy, naturalness, and emotional consistency of synthesized speech across different languages. The various embodiments and features described herein, such as the phoneme generator, spacing character generator, pacing character generator, non-verbal character generator, and post-processing network, collectively contribute to the technical advancements and overall functionality of the invention. These elements, while individually significant, work synergistically within the framework of the invention to achieve the desired improvements in cross-language vocal synthesis, ensuring that the synthesized speech is indistinguishable from human speech in its emotional and prosodic attributes.

The present invention includes a method for synthesizing translated speech from original audio speech in a first language. The method includes acquiring a translated text label in a second language that corresponds to the original audio speech, a speaker identification corresponding to a target speaker, and a language code corresponding to the second language. The method further includes generating a modified text label by converting the translated text label into phonemes, inserting spacing characters into the phonemes to denote pauses in speech, inserting pacing characters into the phonemes to denote the pace of speech, and inserting non-verbal characters into the phonemes to denote non-verbal speech elements. The modified text label, the language code, and speaker identification are then provided to a machine learning model configured to output translated synthetic speech. The method may further include generating a mel spectrogram from the machine learning model based on the modified text label, the language code, and the speaker identification.

The method may also include acquiring an input text label in the first language that corresponds to the original audio speech and translating the input text label to create the translated text label. In some instances, the method includes inputting the translated text label into a phoneme generator to convert the translated text label into phonemes. The phoneme generator may be a neural network trained on a dataset of phonetic representations of words.

Some embodiments also include inputting the original audio speech or a digital representation of the original audio speech into a spacing character generator to insert spacing characters into the phonemes. The spacing character generator is configured to identify pauses by analyzing an amplitude of an audio signal of the original audio speech. Embodiments of the method may further include inputting the original audio speech or a digital representation of the original audio speech into a pacing character generator to insert pacing characters into the phonemes. The pacing character generator is configured to calculate a rate of speech. Likewise, the method may include inputting the original audio speech or a digital representation of the original audio speech into a non-verbal character generator to insert non-verbal characters into the phonemes. The non-verbal character generator may be a neural network trained to recognize patterns in audio.

The present invention further includes a machine learning system for synthesizing translated speech. The system includes one or more processors to acquire an input text label in a first language, acquire a language code corresponding to a second language into which the input text label is to be translated, acquire a translated text label in the second language with the translated text corresponding to input text label, acquire a speaker identification corresponding to a target speaker, acquire a language code corresponding to the second language, generate a modified text label by converting the translated text label into phonemes and performing one or more of: inserting spacing characters into the phonemes to denote pauses in speech; inserting pacing characters into the phonemes to denote the pace of speech; and inserting non-verbal characters into the phonemes to denote non-verbal speech elements. The processor(s) are also configured to provide the modified text label, the language code, and speaker identification to a machine learning model configured to output translated synthetic speech and generate translated speech from the machine learning model based on the modified text label, the language code, and the speaker identification.

The one or more processors are further configured to acquire an input text label in the first language that corresponds to the original audio speech and translate the input text label to create the translated text label. The system is further configured to input the translated text label into a phoneme generator to convert the translated text label into phonemes. The phoneme generator may be a neural network trained on a dataset of phonetic representations of words.

In addition, the one or more processors are configured to input the original audio speech or a digital representation of the original audio speech into a spacing character generator to insert spacing characters into the phonemes. The spacing character generator is configured to identify pauses by analyzing an amplitude of an audio signal of the original audio speech.

The one or more processors are further configured to input the original audio speech or a digital representation of the original audio speech into a pacing character generator to insert pacing characters into the phonemes. The pacing character generator is configured to calculate a rate of speech.

Moreover, the one or more processors are configured to input the original audio speech or a digital representation of the original audio speech into a non-verbal character generator to insert non-verbal characters into the phonemes. The non-verbal character generator is configured to recognize patterns in audio.

The present invention further includes a system and a method for training a machine learning model. The system through one or more processor is configured to perform the steps of the method for training the machine learning model. The steps include: a) acquiring an input text label in a first language; b) acquiring a language code corresponding to the first language; c) acquiring a speaker identification; d) generating a modified text label by converting the translated text label into phonemes and performing one or more of the following steps: inserting spacing characters into the phonemes to denote pauses in speech; inserting pacing characters into the phonemes to denote the pace of speech; inserting non-verbal characters into the phonemes to denote non-verbal speech elements; e) providing the modified text label, the language code, and speaker identification to a machine learning model configured to output a synthetic mel spectrogram; f) comparing the synthetic mel spectrogram to an original mel spectrogram using a predetermined loss function to calculate a loss value; and repeating steps a) through f) until the loss value meets a predetermined threshold.

The steps may further include inputting the input text label into a phoneme generator to convert the input text label into phonemes, wherein the phoneme generator is a neural network trained on a dataset of phonetic representations of words; inputting the original mel spectrogram into a spacing character generator to insert spacing characters into the phonemes, wherein the spacing character generator is configured to identify pauses by analyzing an amplitude of an audio signal of the original mel spectrogram; inputting the original mel spectrogram into a pacing character generator to insert pacing characters into the phonemes, wherein the pacing character generator is configured to calculate a rate of speech; and inputting the original mel spectrogram into a non-verbal character generator to insert non-verbal characters into the phonemes, wherein the non-verbal character generator is configured to recognize patterns in audio.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a block diagram of a prior art approach to training a ML model.

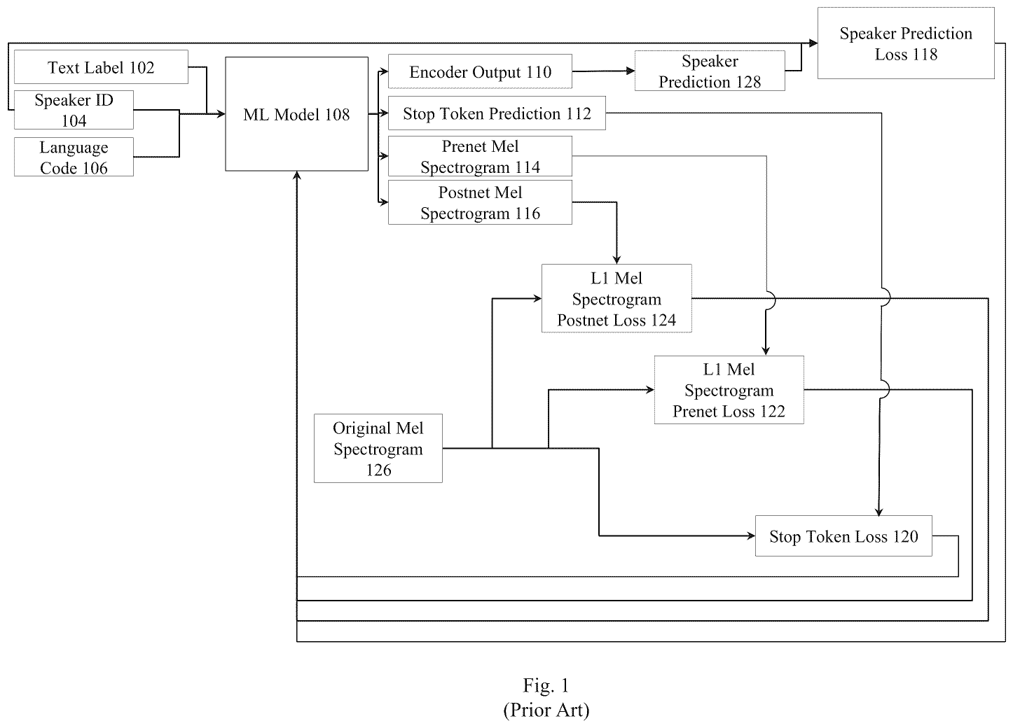

FIG. 2 is a block diagram of inference of the prior art ML model from FIG. 1.

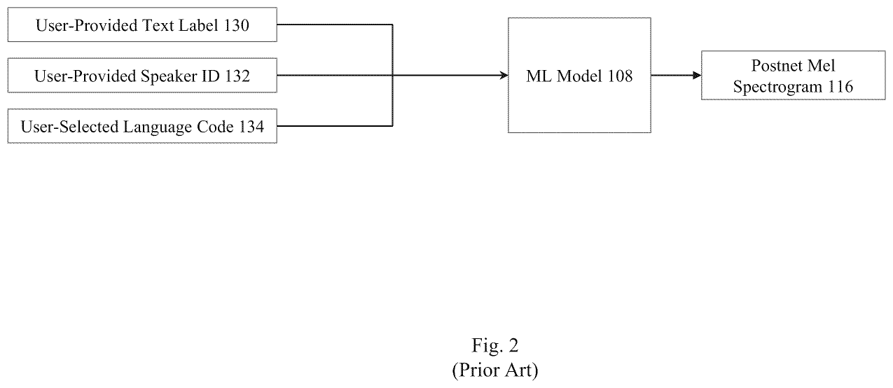

FIG. 3 is a block diagram of an embodiment of the present invention illustrating the modification of the text label using a phoneme generator.

FIG. 4 is a block diagram of an embodiment of the present invention illustrating the training architecture for the embodiment in FIG. 3.

FIG. 5 is a block diagram of an embodiment of the present invention illustrating the modification of the text label using a phoneme generator during inference.

FIG. 6 is a block diagram of an embodiment of the present invention illustrating the modification of the text label using a spacing character generator.

FIG. 7 is a block diagram of an embodiment of the present invention illustrating the training architecture for the embodiment in FIG. 6.

FIG. 8 is a block diagram of an embodiment of the present invention illustrating the modification of the text label using a spacing character generator during inference.

FIG. 9 is a block diagram of an embodiment of the present invention illustrating the modification of the text label using a pacing character generator.

FIG. 10 is a block diagram of an embodiment of the present invention illustrating the training architecture for the embodiment in FIG. 9.

FIG. 11 is a block diagram of an embodiment of the present invention illustrating the modification of the text label using a pacing character generator during inference.

FIG. 12 is a block diagram of an embodiment of the present invention illustrating the modification of the text label using a non-verbal character generator.

FIG. 13 is a block diagram of an embodiment of the present invention illustrating the training architecture for the embodiment in FIG. 12.

FIG. 14 is a block diagram of an embodiment of the present invention illustrating the modification of the text label using a non-verbal character generator during inference.

FIG. 15 is a block diagram of an embodiment of the present invention illustrating the modification of the text label using a phoneme, spacing, pacing, and non-verbal character generator.

FIG. 16 is a block diagram of an embodiment of the present invention illustrating the acquisition of the inputs and the modification of the text label using a phoneme, spacing, pacing, and non-verbal character generator.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments. In various embodiments of the present invention, features described as optional may be included or omitted as appropriate for a particular application. These optional features may be combined in any suitable manner with other aspects of the invention. Specifically, unless explicitly stated otherwise, any feature or combination of features described herein as being optional or included in some embodiments may be included in any embodiment, irrespective of whether such embodiment is explicitly described with that particular feature or combination of features. The scope of the present invention should be understood to encompass any embodiment incorporating one or more optional features as described herein, in any combination or sub-combination.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Referring now to the specifics of the present invention, some embodiments, include one or more computer systems having a memory, a user interface with a visual display (also referred to as a “graphic user interface” or “GUI”), and a processor for executing a program performing at least the steps described herein. In some embodiments, the present invention is a computer executable method or is a method embodied in software for executing the steps described herein. Further explanation of the hardware and software can be found in the Hardware and software infrastructure examples section below.

The system and method of the present invention, through unique processors and generators executing a unique sequence of steps, produces more accurate translations across different languages. In addition, the ML model can account for various speech characteristics (e.g., pacing, pitch, pronunciation, emphasis, tense, emotion, etc.) to ensure that the resulting synthetic speech appears to be realistic. In fact, the present invention has drastically improved the realism of synthetic speech in comparison to existing systems and methods.

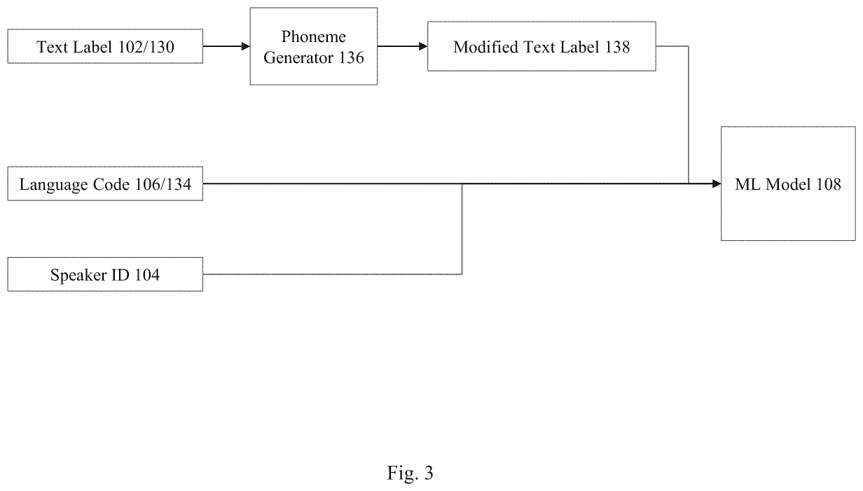

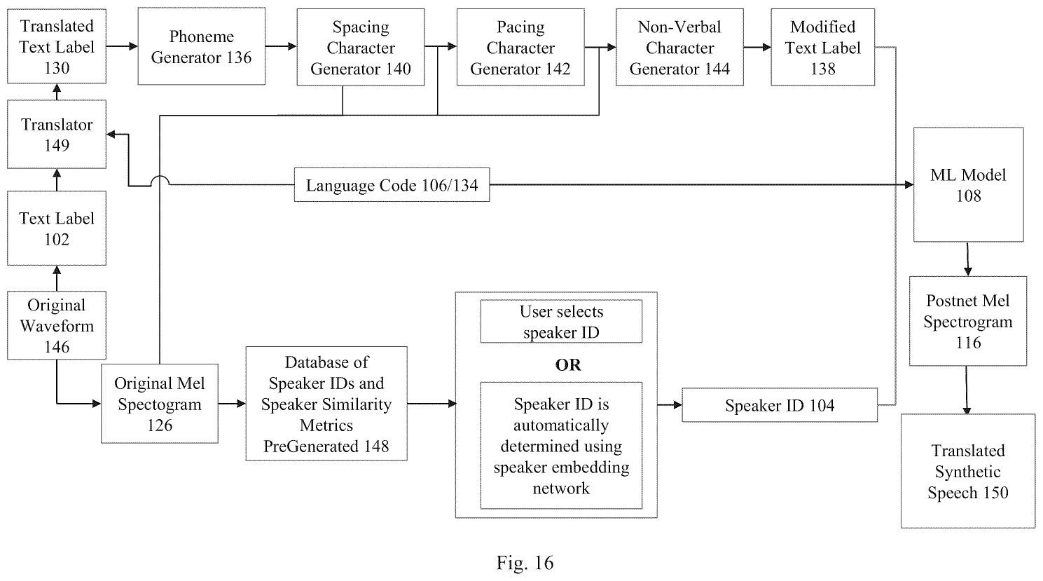

The present invention is a system and method that produces better outputs by modifying the inputs to the ML model. These inputs can be provided by a user and/or automatically determined from the original speech, waveform, or the mel spectrogram of the original speech (also referred to as the original mel spectrogram) as generally depicted in FIG. 16. Referring to FIG. 3, inputs include, but are not limited to text label 102, speaker ID 104, and language code 106.

Text label 102 is the raw text from which a user wants to create synthetic speech. The text can be extracted from the original speech (also referred to as “original verbal communication”) (see FIG. 16), provided by the user, or acquired through other means. During training text label 102 is text in the speaker's original language (e.g., English, Spanish, French, Arabic, Mandarin, etc.). However, during inference the input text label may be translated text label 130, which includes text translated into the desired output language. The desired output language is the language of the desired final translated synthetic speech.

Speaker ID 104 includes a machine-readable collection of speaker attributes or vocal qualities (e.g., volume, pace, pitch, rate, rhythm, fluency, articulation, pronunciation, enunciation, tone, etc.). In some embodiments, speaker ID 104 is a vector representation of the speaker's attributes and may be provided or generated from a ML model. For example, if the ML model is a “many” trained model the speaker ID would be a 1-hot vector with the number of digits in the vector equal to the number of persons, with each person having their own vector. As another example, the ML model could be an “any” trained network configured to receive audio and output a vector that encodes the speaker attributes as a vector based on the detected attributes.

Language code 106 is a machine-readable representation to inform ML model 108 of the language in which the synthetic speech should be produced. During training, language code 106 is a code corresponding to the speaker's original language. However, during inference the language code provided to ML model 108 is language code 134, which is a code corresponding the desired output language, i.e., the translated language.

Referring now to FIG. 3, some embodiments include modifying text label 102 using phoneme generator 136 to produce modified text label 138, which is based on the text provided in original text label 102 and the particular language of the text. The particular language of the text in text label 102 can be identified by a user as an input or automatically detected by phoneme generator 136 or another intermediate language detector. Modified text label 138 is then provided to ML model 108 in place of original text label 102.

Phoneme generator 136 is an ML generator, a lookup table, or any other known module/method/system configured to convert words to phonemes. For example, in some embodiments, phoneme generator 136 comprises a neural network model trained on a dataset of words and their corresponding phonemes, a lookup table mapping words to phonemes, or a combination of both. Phoneme generator 136 may also include preprocessing modules for text normalization and segmentation. For example, a sequence-to-sequence neural network model can be employed to convert text into phonemes. Alternatively, phoneme generator may be or include an International Phonetic Alphabet (IPA) generator that converts input text into its phonetic representation using a predefined lookup table. Phoneme generator 136 may be integrated into the computer system executing the various steps described herein or may be external and accessible via a network, wired, or wireless connection.

It should be noted that the term phoneme refers to any approach for segmenting or distinguishing a word or a portion of a word from another. As noted above, a non-limiting example of phoneme generator 136 is an international phonetic alphabet (IPA) generator, which is an alphabetic system of phonetic notation based primarily on the Latin script. For example, phoneme generator 136 is configured to convert “read” to “ri:d,” “read” (red) to “rεd,” and “carrot” to “kæret.” As a result, ML model 108 does not have to know that “c” and “h” are different from “ch”, or that “c” is different from “ce” (e.g., the “c” becomes an “s”). In addition, the modification of text to phonemes also reduces the number of characters within a language—it does not see “c” and “k,” it just sees “k.”

Phoneme generator 136 is preferably configured to work across all languages. As such, it is either trained or includes a database of universal phonemes corresponding to every word in every language. In some embodiments, phoneme generator 136 is or includes an ML model configured to convert known and unknown words (i.e., words not present in the database) to phonemes. Using ML is useful for slang words and unique names.

Modifying text label 102 using phoneme generator 136 to produce modified text label 138 results in multiple improvements to the functionality of ML model 108 and its corresponding outputs. For example, ML model 108 can be used on languages beyond those on which it was trained, works on languages with aspirated words like Hindi, and converges 20-30 percent faster because of a reduction in the number of characters and edges cases. In addition, the outputs have improved pronunciation especially when used for translation.

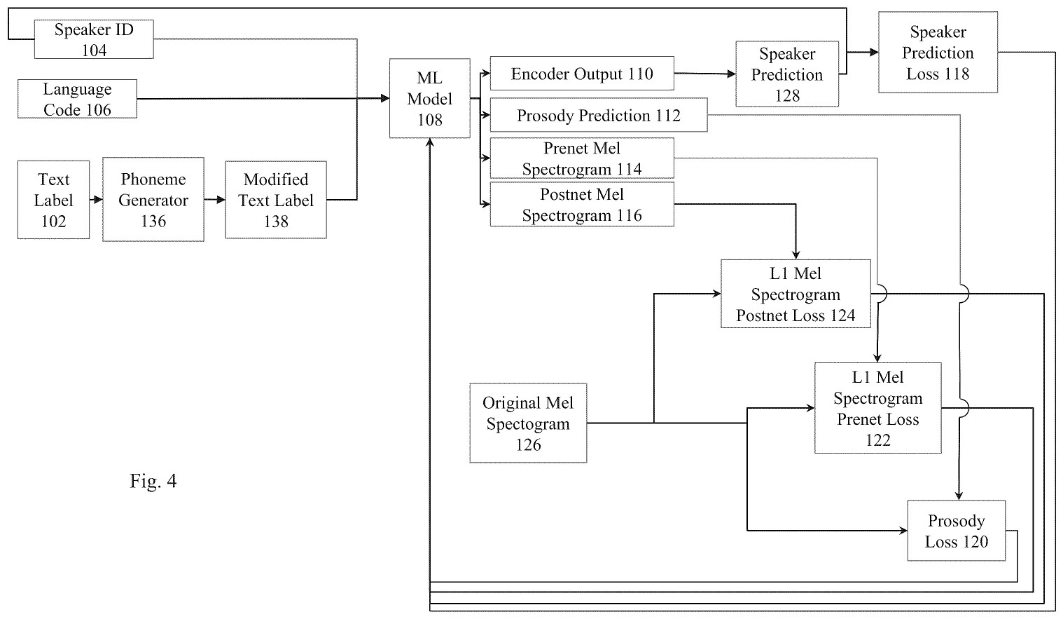

Referring now to FIG. 4, an embodiment of the present invention is provided depicting training architecture for ML model 108 using phoneme generator 136 and modified text label 138. As depicted therein, ML model 108 is trained using modified text label 138 rather than original text label 102. As noted above, text label 102 is in the non-translated language during training. Phoneme generator 136 receives original text label 102 and converts the text in text label 102 into phonemes. The output from phoneme generator 136 is modified text label 138 in which the text is now represented by phonemes. ML Model 108 outputs encoder output 110, prosody prediction 112, prenet mel spectrogram 114, and/or postnet mel spectrogram 116. Each of these outputs are analyzed using their corresponding loss functions. Non-limiting examples of loss functions include Mean Squared Error (MSE) Loss, Mean Absolute Error (MAE) Loss, Cross-Entropy Loss, Binary Cross-Entropy Loss, Kullback-Leibler (KL) Divergence Loss, Prosody Loss, Spectral Convergence Loss, and Logarithmic Distance Loss.

As will be explained below, some of the loss functions incorporate original mel spectrogram 126. Original mel spectrogram 126 is the mel spectrogram of the original audio speech corresponding to the original text label 102. It should be noted that alternative digital representations of the original speech can be used instead or in addition to the mel spectrogram. Non-limiting examples include representing the original speech by an alternative spectrogram or a waveform. For the sake of brevity, the term “mel spectrogram” will be used hereinafter to refer to any digital representation of speech.

Some embodiments include encoder output 110, which can be used to output speaker prediction 128. Speaker prediction loss 118 is then calculated based on a predetermined loss function that compares speaker ID 104 to speaker prediction 128. In some embodiments, speaker prediction 128 is output from postnet mel spectrogram 116.

Some embodiments include prosody loss 120. Prosody loss 120 is calculated based on a predetermined loss function that compares prosody prediction 112 with the original prosody (i.e., length of time) of the original mel spectrogram 126. In some embodiments, prosody prediction 112 is based on the length of every phoneme from the output mel spectrogram and prosody loss is based on the comparison of prosody prediction 112 with the length of every phoneme in original mel spectrogram 126. Some embodiments use the overall length of the mel spectrograms and/or the length of predetermined sections to determine prosody loss rather than individual phoneme length.

In some embodiments, L1 mel spectrogram prenet loss 122 is calculated using a predetermined loss function that compares prenet mel spectrogram 114 with pixel value similarities with the original mel spectrogram 126. Likewise, L1 mel spectrogram postnet loss 124 is calculated using a predetermined loss function that compares postnet mel spectrogram 116 with original mel spectrogram 126.

In some embodiments, ML model 108 outputs a single mel spectrogram rather than both a prenet and postnet mel spectrogram. The single mel spectrogram may be either the prenet or postnet mel spectrogram and the corresponding loss function is used to determine loss in comparison with original mel spectrogram 126. Likewise, some embodiments of ML model 108 output only postnet mel spectrogram 116 and not outputs 110-114. L1 mel spectrogram postnet loss 124 is then calculated using a predetermined loss function that compares postnet mel spectrogram 116 with original mel spectrogram 126.

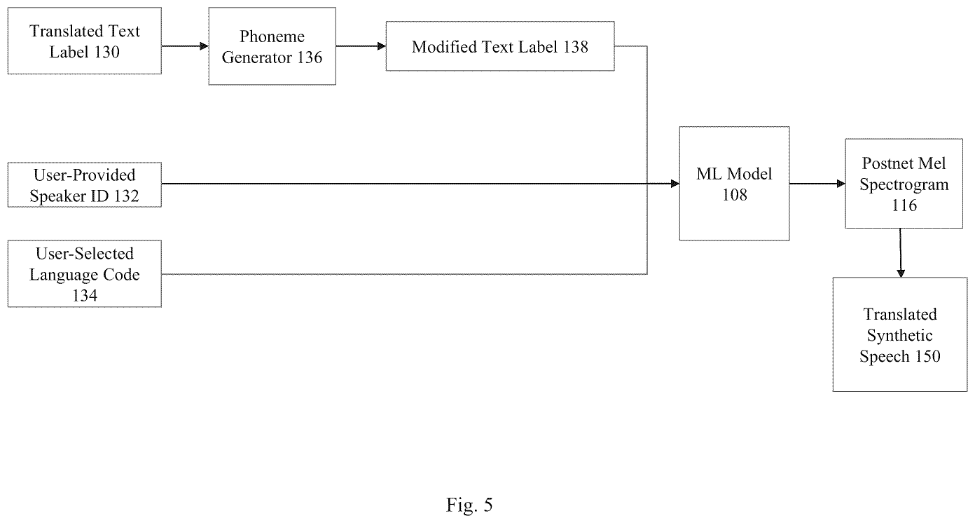

Once the one or more loss values are calculated from the loss functions, the loss values are each input back into ML model 108. ML model 108 uses these loss value inputs to continue learning by adjusting parameters of the output(s) (e.g., one or more of 110-116) until acceptable levels of loss are calculated. Once acceptable levels are reached, ML model 108 is considered trained and can be used during inference, which is exemplified in FIG. 5.

As shown in FIG. 5, translated text label 130 is used to produce postnet mel spectrogram 116, which is eventually transformed into translated synthetic speech 150. Translated text label 130 can be provided by a user, derived by automatically translating the original speech or original mel spectrogram, or through any other methods, models, or systems. Translated text label 130 is provided to phoneme generator 136, which converts the text into phonemes to produce modified text label 138. Rather than providing the translated text to ML model 108, a phoneme representation referred to as “modified text label 138” is provided as an input to ML model 108 along with speaker ID 132 and language code 134. As previously explained, language code 134 is a language code for the desired translated language during inference. Model 108 uses the inputs to produce postnet mel spectrogram 116, which is converted into translated synthetic speech 150 corresponding to translated text label 130 and speaker ID 132.

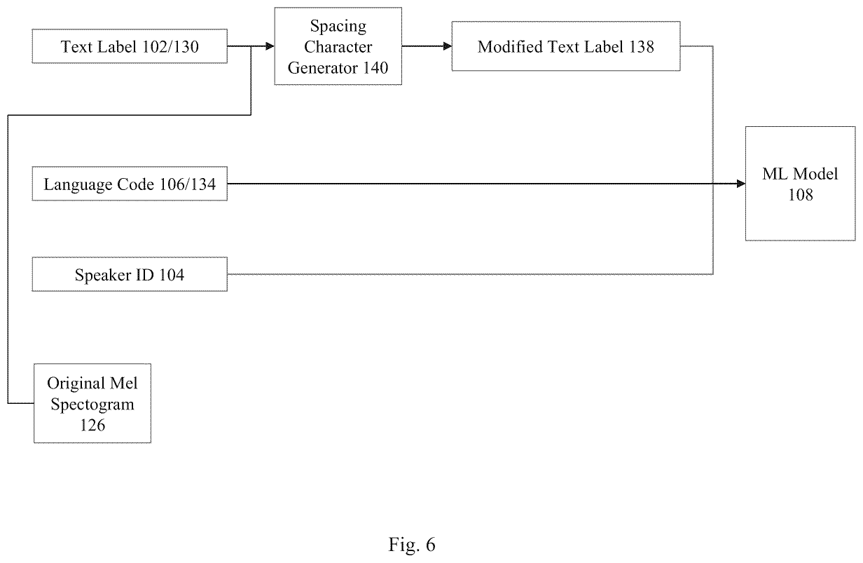

Referring now to FIG. 6, some embodiments include generating modified text label 138 by modifying text label 102/130 using spacing character (SC) generator 140. Modified text label 138 with spacing character is then provided to ML model 108 in place of original text label 102.

SC generator 140 may be integrated into the computer system executing the various steps described herein. Alternatively, SC generator 140 may be external and accessible via a network, wired, or wireless connection.

SC generator 140 is a ML generator, algorithm, image analyzer, or any other known module/method/system configured to identify pauses in speech from a mel spectrogram or another format of speech. For example, SC generator 140 may be a convolutional neural network (CNN) trained to identify pauses in a mel spectrogram or a digital signal processing (DSP) module that detects periods of low amplitude in the speech signal and inserts a predefined spacing character into the text. The DSP module may analyze the signal to detect when the amplitude falls below a threshold (e.g., 40 dB) for a specific duration (e.g., 0.1 seconds), indicating a pause. As a result, SC generator 140 can effectively incorporate pauses into the text label, improving the naturalness of the synthesized speech. SC generator 140 may be integrated into the computer system executing the various steps described herein or may be external and accessible via a network, wired, or wireless connection.

In some embodiments, SC generator 140 receives original mel spectrogram 126 and text label 102/130 as inputs. SC generator 140 identifies pauses in speech in the original speech based on a predetermined gap in the measured waveform. For the original mel spectrogram 126, SC generator 140 identifies when the decibel level is below a predetermined threshold for a predetermined period of time. In some embodiments, the threshold decibel level to indicate a pause is about or below 40 dB.

In some embodiments, the period of time is between 0.1 and 0.5 seconds. In some embodiments, the predetermined time is 0.1 seconds. For each 0.1 seconds of pause, SC generator 140 inputs a special character into text label 102/130 to produce modified text label 138. Special characters can be any characters that are not letters, numbers, or punctuation. For example, some embodiments use “>” to denote pauses.

Incorporating these special characters into text label 102/130 enables model 108 to learn a mapping between a text input and a silent output. Once trained, ML model 108 interprets the spacing characters as pauses and incorporates the pauses into the output. The approach results in the following improvements: fixes large-scale pacing issues when pauses are present, allows for major pauses between words, enables the user during inference to control pauses between words by inserting or removing the spacing character, helps the model train and converge because it doesn't have to guess where to pause, which makes the model 5%-10% faster/cheaper.

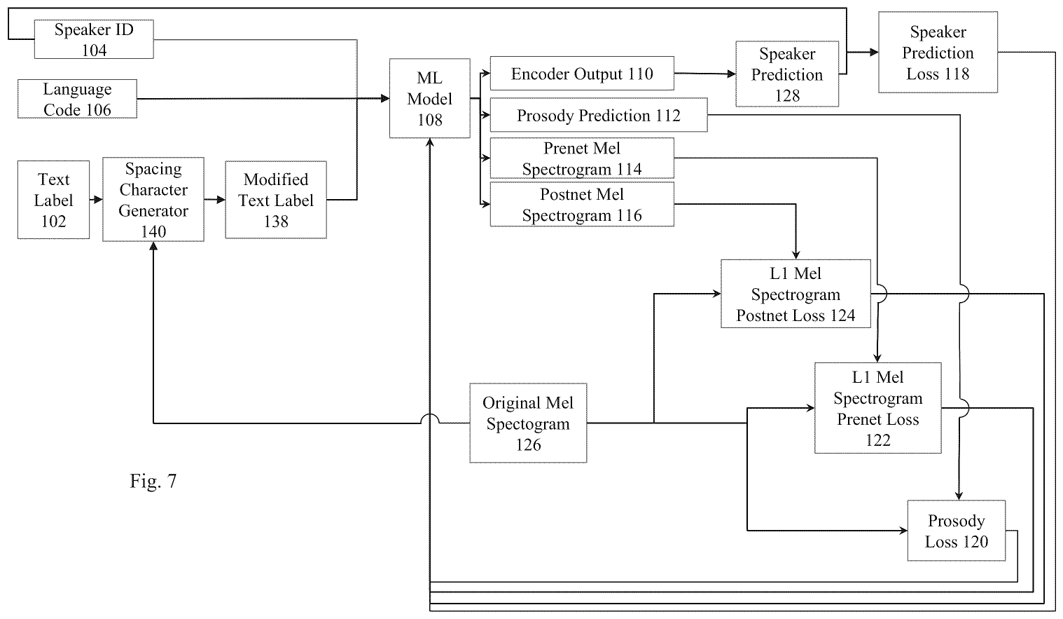

Referring to FIG. 7, an embodiment of the present invention is provided depicting training architecture for ML model 108 using SC generator 140 and the resulting modified text label 138. As depicted therein, ML model 108 is trained using modified text label 138 rather than original text label 102. As noted above, text label 102 is in the non-translated language during training. SC generator 140 receives original text label 102 and original mel spectrogram 126. SC generator 140 modifies the text in text label 102 to include special characters that denote any detected pauses in speech. The output from SC generator 140 is modified text label 138 which now includes the special spacing characters. ML Model 108 outputs one or more of encoder output 110, prosody prediction 112, prenet mel spectrogram 114, and/or postnet mel spectrogram 116. Each of these outputs are analyzed using their corresponding loss functions as described above in relation to training model 108 using phoneme generator 136. Again, some embodiments of ML model 108 output only postnet mel spectrogram 116. L1 mel spectrogram postnet loss 124 is then calculated using a predetermined loss function that compares postnet mel spectrogram 116 with original mel spectrogram 126.

Once the one or more loss values are calculated from the loss functions, the loss values are each input back into ML model 108. ML model 108 uses these loss value inputs to continue learning by adjusting parameters of the output(s) (e.g., one or more of 110-116) until acceptable levels of loss are calculated. Once acceptable levels are reached, ML model 108 is considered trained.

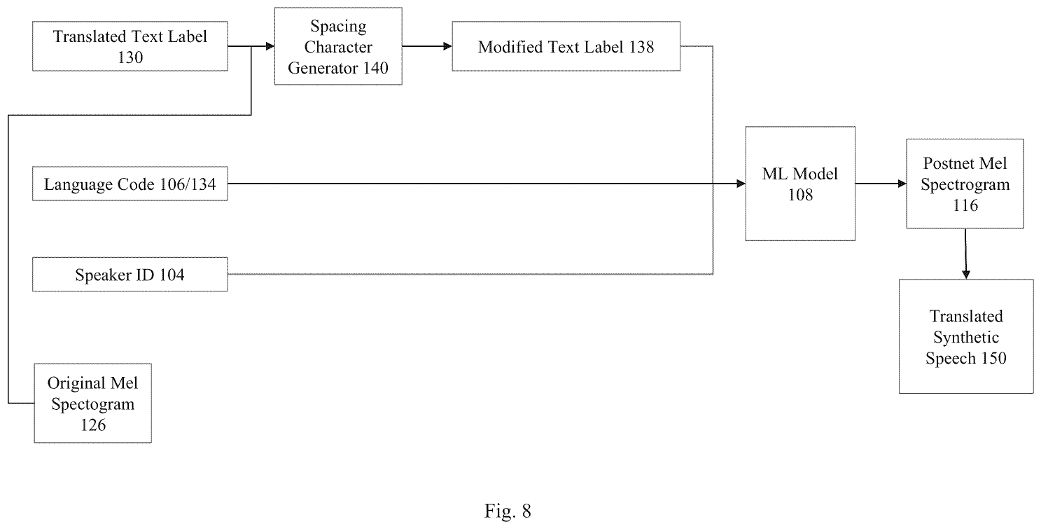

Once model 108 is trained, it can be used during inference, which is depicted in FIG. 8. As depicted therein, translated text label 130 is used to produce postnet mel spectrogram 116, which is eventually turned into synthetic speech 150. Regardless of how translated text label 130 is acquired, translated text label 130 is provided to SC generator 140. SC generator 140 modifies the text in translated text label 130 to include special characters that denote any detected pauses in speech to produce modified text label 138. Rather than providing the translated text to ML model 108, modified text label 138 is provided as an input to ML model 108 along with speaker ID 132 and user selected language code 134. As previously explained, language code 134 is a language code corresponding to the desired translated language during inference. ML model 108 uses the inputs to produce postnet mel spectrogram 116, which can be converted into translated synthetic speech 150, which corresponds to translated text label 130 and speaker ID 132.

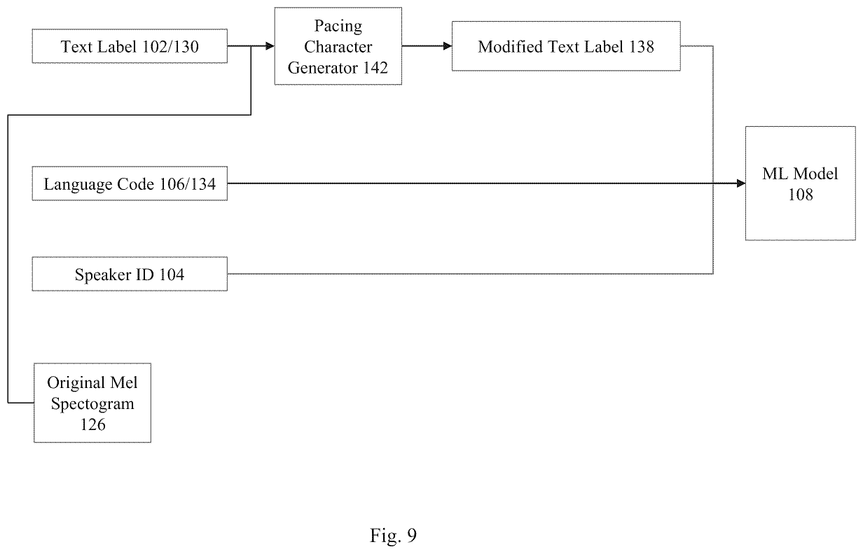

Referring now to FIG. 9, some embodiments include generating modified text label 138 by modifying text label 102/130 using pacing character (PC) generator 142. Modified text label 138 with “pacing” characters is then provided to ML model 108 in place of original text label 102. PC generator 142 may be integrated into the computer system executing the various steps described herein or may be external and accessible via a network, wired, or wireless connection.

PC generator 142 is a ML generator, algorithm, image analyzer, or any other known module/method configured to identify the pace of speech from a mel spectrogram or another format of speech. For example, PC generator 142 may be or include a recurrent neural network (RNN) that analyzes the time intervals between phonemes in a mel spectrogram and inserts pacing characters into the text label. PC generator 142 may also include a speech rate detection algorithm that calculates the average number of phonemes spoken per second and adjusts the text accordingly. The use of pacing characters enables the ML model 108 to mimic various speaking speeds, improving prosody and alignment, thereby enhancing the quality of the synthetic speech.

As depicted in FIG. 9, PC generator 142 receives original mel spectrogram 126 and text label 102/130 as inputs. Using original mel spectrogram 126, PC generator 142 identifies the pace of the original speech based on the rate at which characters, phonemes, words, or sentences are spoken. Determining the rate of speech can be accomplished using any methods known in the art. A non-limiting example for determining the pace of speech is to calculate the average characters in the text label that are spoken per second (or per some other set period of time) as identifiable in the mel spectrogram.

PC generator 142 uses a pacing character to denote the speed at which a phoneme, word, or sentence is spoken in original mel spectrogram 126. The pacing character is input into text label 102/130 to produce modified text label 138. In some embodiments, special characters can be characters that are not letters, numbers, or punctuation. For example, some embodiments use “#” as a pacing character, which denotes a pace of a predetermined length.

Some embodiments include a single pacing character to denote a specific length of time. Multiples of the same character can be added to the beginning of a word to indicate the length of time for which the word is spoken, for example “## #example” indicates that the word “example” is spoken at a pace equal to three times the period of time represented by “#.” Alternatively, multiple different characters are used with each character indicating a different period of time. In some embodiments, each pacing character represents a time period of 0.5 seconds. In some embodiments, each pacing character represents a time period between 0.5 and 1.5 seconds.

Incorporating pacing characters into text labels 102/130 enables ML model 108 to learn a mapping between a text-input and the pace of the output. The approach results in the following improvements: helps prosody loss and alignment—the ML model has a general idea of how long the generated speech should be from the text, helps the ML model mimic slow-talking/fast-talking, increases the ML model's convergence speed and reduces cost by 5%-10%.

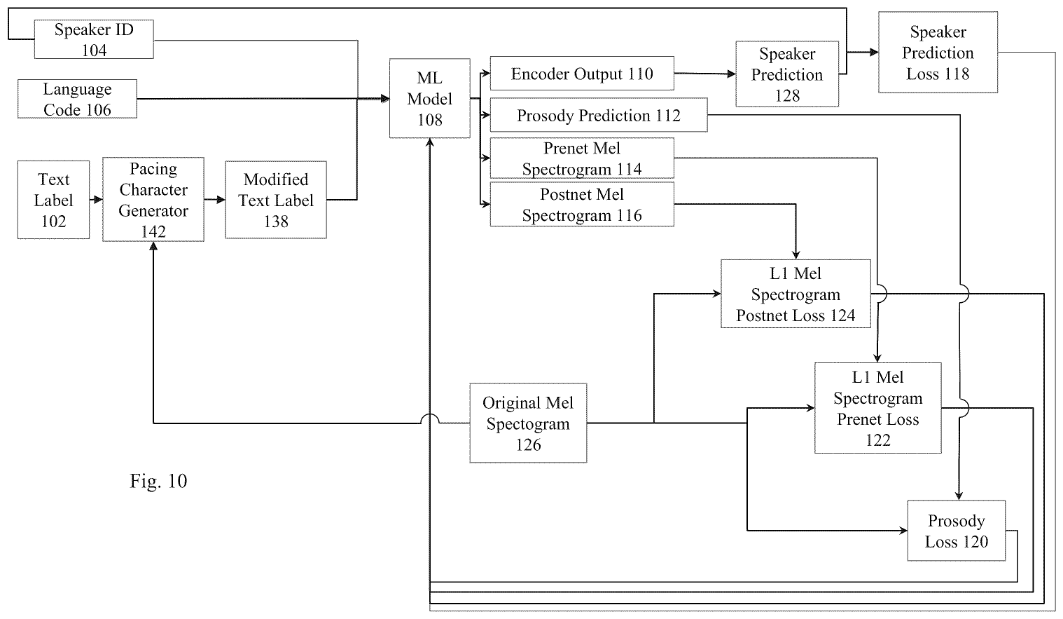

Referring to FIG. 10, an embodiment of the present invention is provided depicting training architecture for ML model 108 using PC generator 142 and modified text label 138. As depicted therein, ML model 108 is trained using modified text label 138 rather than original text label 102. As noted above, text label 102 is in the non-translated language during training. PC generator 142 receives original text label 102 and original mel spectrogram 126. PC generator 142 modifies the text in text label 102 to include special characters that denote the rate of speech for each phoneme, word, or sentence. The output from PC generator 142 is modified text label 138 which now includes the pacing characters. ML Model 108 outputs encoder output 110, prosody prediction 112, prenet mel spectrogram 114, and/or postnet mel spectrogram 116. The one or more outputs are analyzed using their corresponding loss functions as described above in relation to training model 108 using other generators 136, 138, and 140.

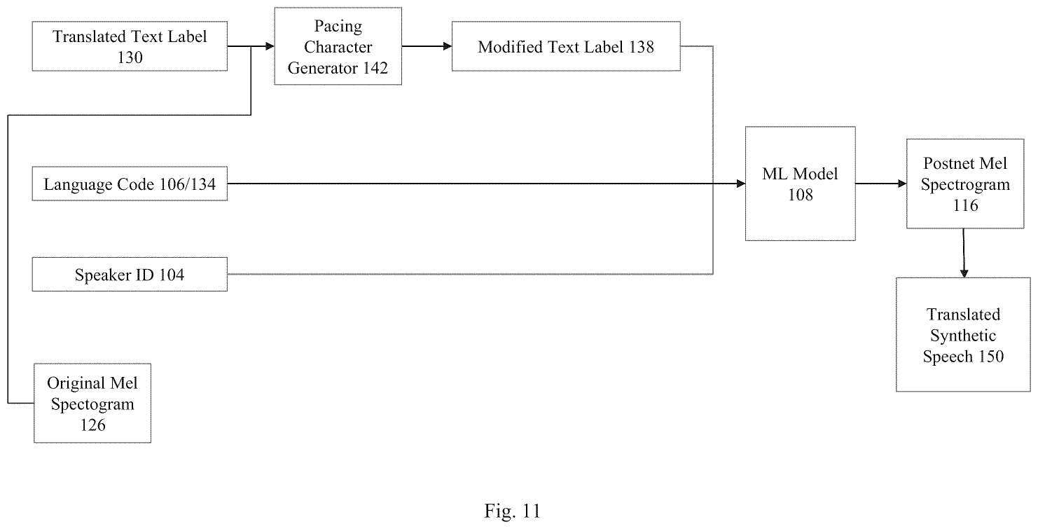

Once model 108 is trained, it can be used during inference, which is depicted in FIG. 11. As depicted therein, translated text label 130 is used to produce postnet mel spectrogram 116, which is eventually turned into synthetic speech. Regardless of how translated text label 130 is acquired, translated text label 130 is provided to PC generator 142. PC generator 142 modifies the text in translated text label 130 to include special characters that denote the rate of speech to produce modified text label 138. Rather than providing the translated text to model 108, modified text label 138 is provided as an input to model 108 along with speaker ID 132 and user selected language code 134. As previously explained, language code 134 is a language code for the desired translated language during inference. ML model 108 uses the inputs to produce postnet mel spectrogram 116, which can be converted into translated synthetic speech 150 corresponding to translated text label 130 and speaker ID 132.

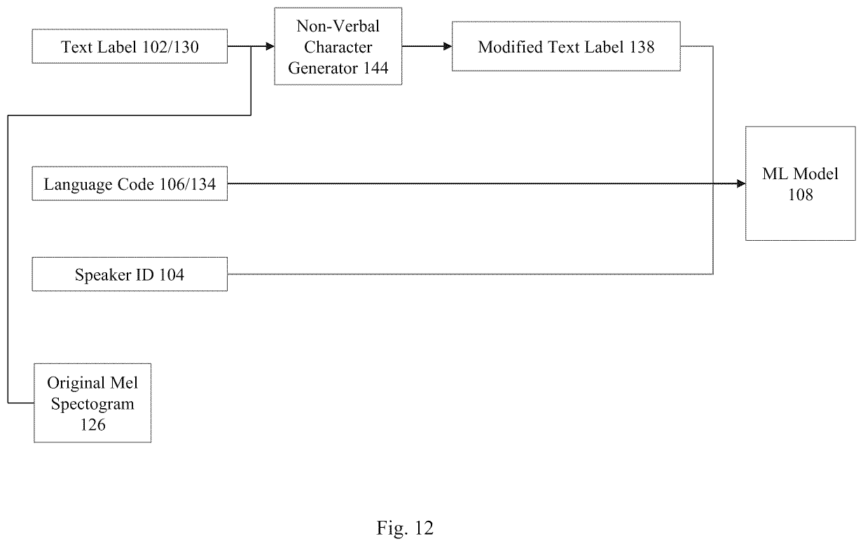

Referring now to FIG. 12, some embodiments include generating modified text label 138 by modifying text label 102/130 using non-verbal character (NVC) generator 144. Modified text label 138 is provided to ML model 108 in place of original text label 102/130.

NVC generator 144 is a ML generator, algorithm, image analyzer, or any other known module/method configured to identify non-verbal speech from a mel spectrogram or another format of speech in comparison to the text label. For example, NVC generator 144 may include a combination of a CNN and a RNN that detects non-verbal speech elements such as coughs, laughs, and breaths in a mel spectrogram. NVC generator 144 can also include specialized feature extraction modules that identify non-verbal patterns in the speech signal, such as FDY-CRNN or DENet models. NVC generator 144 may be integrated into the computer system executing the various steps described herein or may be external and accessible via a network, wired, or wireless connection.

NVC generator 144 receives original mel spectrogram 126 and text label 102/130 as inputs. Using original mel spectrogram 126, NVC generator 144 identifies instances in which non-verbal speech occurs by comparing the frequency values in the mel spectrogram to the text in the text label. Non-limiting examples of non-verbal speech include coughs, sneezes, hums, breath, laughs, etc. NVC generator 144 modifies text label 102/130 to include NVCs at locations within the text where non-verbal speech occurs in original mel spectrogram 126.

NVCs can be any characters that are not letters, numbers, or punctuation. For example, some embodiments use “*” to denote breath, “&” to indicate a cough, and “+” to indicate a laugh. As such, ML model 108 can learn when to input specific types of non-verbal speech into the output. Accounting for non-verbal speech also increases the model's convergence speed and reduces cost by 5%-10%.

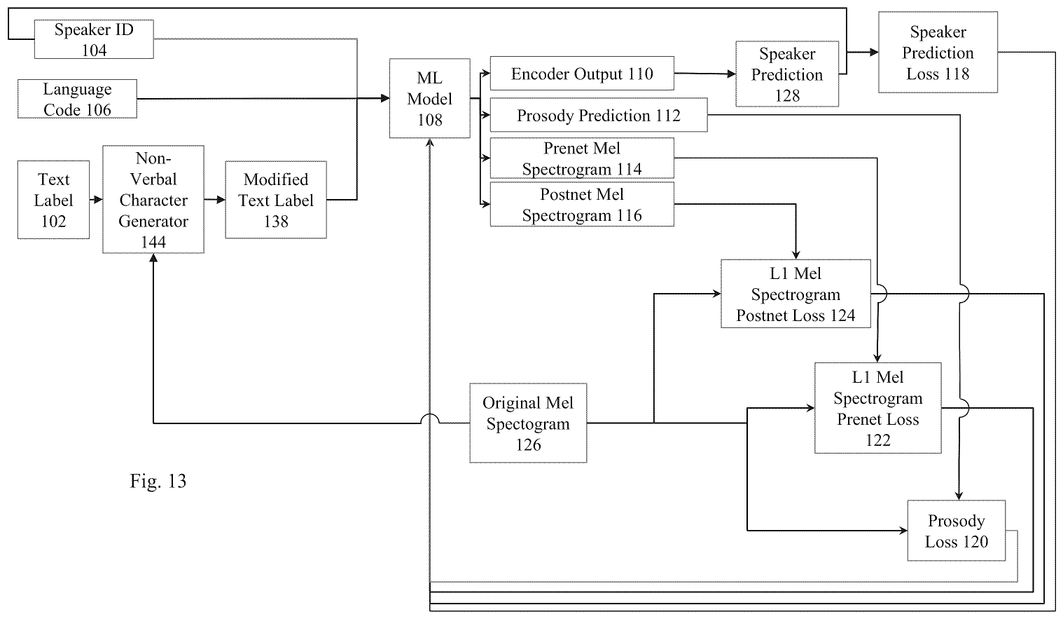

Referring to FIG. 13, an embodiment of the present invention is provided depicting training architecture for ML model 108 using NVC generator 144 and modified text label 138. As depicted therein, ML model 108 is trained using modified text label 138 rather than original text label 102. Again, text label 102 is in the non-translated language during training. NVC generator 144 receives original text label 102 and original mel spectrogram 126. NVC generator 144 modifies the text in text label 102 to include special characters that denote non-verbal speech. The output from NVC generator 144 is modified text label 138 which now includes the NVCs. ML Model 108 outputs encoder output 110, prosody prediction 112, prenet mel spectrogram 114, and/or postnet mel spectrogram 116. Each of these outputs are analyzed using their corresponding loss functions as described above in relation to training ML model 108 using the other generators 136, 138, 140, and 142.

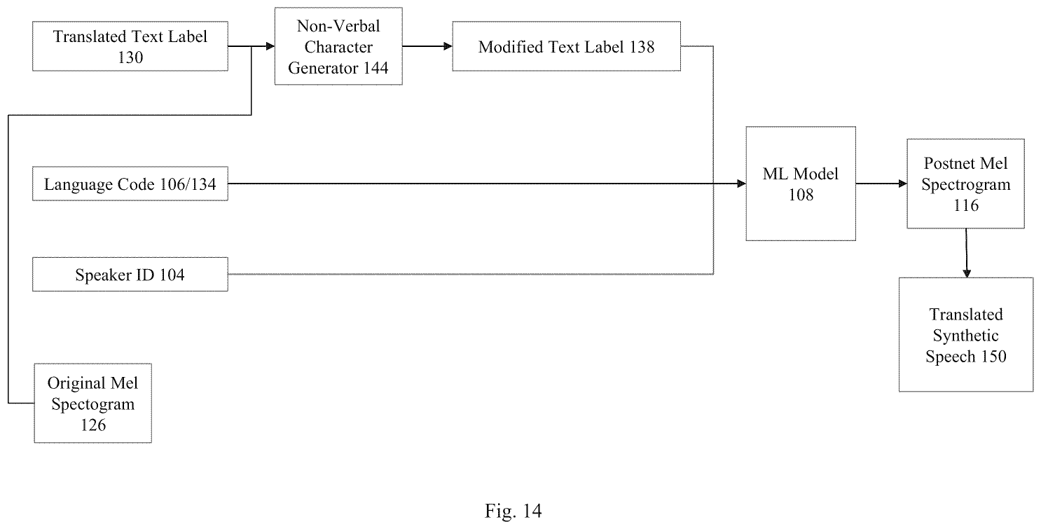

Once ML model 108 is trained, it can be used during inference, which is depicted in FIG. 14. As depicted therein, translated text label 130 is used to produce postnet mel spectrogram 116, which is eventually turned into translated synthetic speech 150. Regardless of how translated text label 130 is acquired, translated text label 130 is provided to NVC generator 144. NVC generator 144 modifies translated text label 130 to include NVCs to produce modified text label 138. Rather than providing the translated text to model 108, modified text label 138 is provided as an input to model 108 along with speaker ID 132 and user selected language code 134. As previously explained, language code 134 is a language code for the desired translated language during inference. ML model 108 uses the inputs to produce postnet mel spectrogram 116, which can be converted into translated synthetic speech 150 corresponding to translated text label 130 and speaker ID 132.

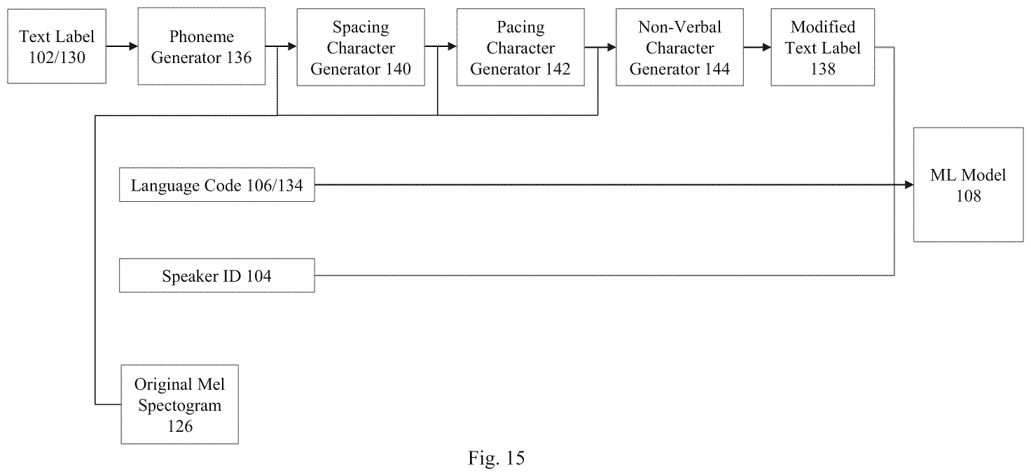

Some embodiments includes one or more of phoneme generator 136, SC generator 140, PC generator 142, and NVC generator 144 to modify text label 102/130 into modified text label 138. Any combination of one or more of phoneme generator 136, SC generator 140, PC generator 142, and NVC generator 144 will improve ML model 108 beyond prior art approaches. Some embodiments include using all of phoneme generator 136, SC generator 140, PC generator 142, and NVC generator 144 as shown in FIG. 15. In some embodiments, phoneme generator 136 is the first generator to modify text label 102/130; however, each of the other generators can be applied in an alternative order from the order depicted in FIG. 15.

Similar to the previous training approaches, an embodiment using more than one of the generators 136-144 to produce modified text label 138 can be trained in the same manner as depicted in FIGS. 4, 7, 10, and 13. Likewise, the same approach applies to inferences when using more than one of the generators 136-144 to produce modified text label 138.

In some embodiments, a user is provided with access and the ability to adjust modified text label 138 after one or more of generators 136-144 modifies text label 102/130. As a result, ML model 108 receives improved inputs to maximize the realism of the outputs.

As provided in FIG. 16, one or more of text label 102/130, language code 106/134, and speaker ID 104 can be input/selected by a user or extracted from the original waveform 146 of the original speech. Original waveform 146 can be converted into original mel spectrogram 126 and text label 102 using known approaches/modules, such as those described herein. Using original mel spectrogram 126 and a database 148 of speaker IDs, a speaker ID generator can automatically select a speaker ID that matches or most closely matches the characteristics of the original speech or the user can select the speaker ID.

Knowing the foreign language code 134 for the translation also allows the system to automatically translate the original text label 102, via translator 149, into the translated text label 130 prior to modifying the text label via one or more of generators 136-144. As such, some embodiments only require an original speech input and a desired foreign language input to create text label 102/130, language code 106/134, and speaker ID 104 and ultimately produce translated synthetic speech 150.

Some embodiments further include ML model 108 configured to intake original mel spectrogram 126 as an input. ML Model 108 uses original mel spectrogram 126 to determine prosody and pitch and outputs an output mel spectrogram with similar prosody and pitch.

Some embodiments include a real or fake discriminator to determine when the model outputs a real or fake output based on identifiable features. Such embodiments use this GAN approach with a corresponding loss function to produce audio that is more realistic.

Some embodiments include additional loss functions. For example, some embodiments include a pitch loss function. The pitch loss function compares the pitch of original mel spectrogram 126 to the output mel spectrogram to determine if the pitch matches or at least achieves a threshold loss value. In some embodiments, the system uses a trained ML network to predict the pitch of original mel spectrogram 126 and/or the output mel spectrogram. Some embodiments use a PYIN algorithm converted into a ML language to keep track of gradient accumulations to predict pitch.

### Hardware and Software Infrastructure Examples

The present invention may be embodied on various computing systems and/or platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object-oriented programming language such as Java, C#, C++, Visual Basic or the like and conventional procedural programming languages, such as the “C” programming language or similar programming languages.

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A method for synthesizing translated speech from original audio speech in a first language, comprising:
acquiring a translated text label, wherein the translated text label is in a second language and corresponds to the original audio speech;
acquiring a speaker identification corresponding to a target speaker;
acquiring a language code corresponding to the second language;
generating a modified text label by:
converting the translated text label into phonemes;
inserting spacing characters into the phonemes to denote pauses in speech;
inserting pacing characters into the phonemes to denote the pace of speech;
inserting non-verbal characters into the phonemes to denote non-verbal speech elements; and
providing the modified text label, the language code, and speaker identification to a machine learning model configured to output translated synthetic speech.

2. The method of claim 1, further including generating a mel spectrogram from the machine learning model based on the modified text label, the language code, and the speaker identification.

3. The method of claim 1, further including acquiring an input text label in the first language that corresponds to the original audio speech and translating the input text label to create the translated text label.

4. The method of claim 1, further including inputting the translated text label into a phoneme generator to convert the translated text label into phonemes, wherein the phoneme generator is a neural network trained on a dataset of phonetic representations of words.

5. The method of claim 1, further including inputting the original audio speech or a digital representation of the original audio speech into a spacing character generator to insert spacing characters into the phonemes, wherein the spacing character generator is configured to identify pauses by analyzing an amplitude of an audio signal of the original audio speech.

6. The method of claim 1, further including inputting the original audio speech or a digital representation of the original audio speech into a pacing character generator to insert pacing characters into the phonemes, wherein the pacing character generator is configured to calculate a rate of speech.

7. The method of claim 1, further including inputting the original audio speech or a digital representation of the original audio speech into a non-verbal character generator to insert non-verbal characters into the phonemes, wherein the non-verbal character generator includes a neural network trained to recognize patterns in audio.

8. A machine learning system for synthesizing translated speech having one or more processors to:
acquire an input text label in a first language;
acquire a language code corresponding to a second language into which the input text label is to be translated;
acquire a translated text label, wherein the translated text label is in the second language and corresponds to input text label;
acquire a speaker identification corresponding to a target speaker;
acquire a language code corresponding to the second language;
generate a modified text label by converting the translated text label into phonemes and performing one or more of the following steps:
inserting spacing characters into the phonemes to denote pauses in speech;
inserting pacing characters into the phonemes to denote the pace of speech;
inserting non-verbal characters into the phonemes to denote non-verbal speech elements;
provide the modified text label, the language code, and speaker identification to a machine learning model configured to output translated synthetic speech; and
generate translated speech from the machine learning model based on the modified text label, the language code, and the speaker identification.

9. The system of claim 8, wherein the one or more processors are further configured to acquire an input text label in the first language that corresponds to the original audio speech and translate the input text label to create the translated text label.

10. The system of claim 8, wherein the one or more processors are further configured to input the translated text label into a phoneme generator to convert the translated text label into phonemes, wherein the phoneme generator is a neural network trained on a dataset of phonetic representations of words.

11. The system of claim 8, wherein the one or more processors are further configured to input the original audio speech or a digital representation of the original audio speech into a spacing character generator to insert spacing characters into the phonemes, wherein the spacing character generator is configured to identify pauses by analyzing an amplitude of an audio signal of the original audio speech.

12. The system of claim 8, wherein the one or more processors are further configured to input the original audio speech or a digital representation of the original audio speech into a pacing character generator to insert pacing characters into the phonemes, wherein the pacing character generator is configured to calculate a rate of speech.

13. The system of claim 8, wherein the one or more processors are further configured to input the original audio speech or a digital representation of the original audio speech into a non-verbal character generator to insert non-verbal characters into the phonemes, wherein the non-verbal character generator is configured to recognize patterns in audio.

14. A method for training a machine learning model, comprising:
a) acquiring an input text label in a first language;
b) acquiring a language code corresponding to the first language;
c) acquiring a speaker identification;
d) generating a modified text label by converting the translated text label into phonemes and performing one or more of the following steps:
inserting spacing characters into the phonemes to denote pauses in speech;
inserting pacing characters into the phonemes to denote the pace of speech;
inserting non-verbal characters into the phonemes to denote non-verbal speech elements;
e) providing the modified text label, the language code, and speaker identification to a machine learning model configured to output a synthetic mel spectrogram;
f) comparing the synthetic mel spectrogram to an original mel spectrogram using a predetermined loss function to calculate a loss value; and
g) repeating steps a) through f) until the loss value meets a predetermined threshold.

15. The method of claim 14, further including inputting the input text label into a phoneme generator to convert the input text label into phonemes, wherein the phoneme generator is a neural network trained on a dataset of phonetic representations of words.

16. The method of claim 14, wherein inserting spacing characters into the phonemes includes inputting the original mel spectrogram into a spacing character generator that is configured to identify pauses by analyzing an amplitude of an audio signal of the original mel spectrogram.

17. The method of claim 14, wherein inserting pacing characters into the phonemes includes inputting the original mel spectrogram into a pacing character generator that is configured to calculate a rate of speech.

18. The method of claim 14, wherein inserting non-verbal characters into the phonemes includes inputting the original mel spectrogram into a non-verbal character generator that is configured to recognize patterns in audio.
